(19) United States
(12) Patent Application Publication
(10) Pub. No.: US 2002/0126102 A1
(43) Pub. Date: Sep. 12, 2002

(54) Extended touch screen

(76) Inventor: Derek Vincent Redmayne, Tsawwassen (CA)

Correspondence Address: Office of Intellectual Property Counsel, 3M Innovative Properties Company, PO Box 33427, St. Paul, MN, 55133-3427, US

(21) Appl. No.: 10/044,043

(22) Filed: Jan. 9, 2002

Related U.S. Application Data
(63) Continuation of application No. 09/532,888, filed on Mar. 22, 2000, now abandoned.
Application No. 09/532,888 is a continuation of application No. 08/288,967, filed on Aug. 10, 1994, now abandoned.
Application No. 08/288,967 is a continuation of application No. 08/033,847, filed on Mar. 19, 1993, now abandoned.

(51) Int. Cl. G09G 5/00

(52) U.S. Cl. 345/173

(57) ABSTRACT

A touch-sensitive panel is mounted in front of a display having a display area. The panel covers an area substantially larger than the display area. A first notional portion of the panel covers the display area and a second notional portion covers an additional area peripheral to the display area. Touch symbols may be applied directly to the first and/or second portions of the panel. However, they are preferably applied to a sheet mounted adjacent to the panel. A first portion of the sheet corresponds to the display area, and a second portion corresponds to the second portion of the panel. In most cases the touch symbols are applied to the second portion of the sheet, although they may in some cases be applied to the first portion of the sheet. The symbols can be configured on the sheet to define a keyboard having a plurality of keys adapted to perform a generalized input function. The display, the panel and the sheet can be sealed within a unitary, waterproof enclosure.

### FIELD OF THE INVENTION

This application pertains to a touch screen having a touch-sensitive area which extends beyond the periphery of the screen's information display area.

### BACKGROUND OF THE INVENTION

A touch screen is an electronic input device which can be mounted in front of an output device such as a computer display. By touching different points on the outer face of the touch screen an operator may communicate corresponding commands to electronic circuitry coupled to the touch screen.

Conventionally, the operator's touch is guided by graphical or textual touch symbols which are presented on the display. The touch symbols are visible through the transparent touch screen. The location, shape and other characteristics of the touch symbols are governed by computer software which controls the operation of electronic circuitry coupled to the display. This approach is somewhat restrictive, in that the portion of the available display area required to display the touch symbols is unavailable for displaying other information. That is, the display area must perform both an input and an output function. The input function requires that a portion of the available display area be reserved for displaying the touch symbols to guide the operator's touch as aforesaid. The non-reserved display area remains available for the output function, namely the display of information unrelated to the input function. Because the available display area is often small in comparison to the amount of information which must be displayed for adequate performance of either the input or output functions, or both, constraints are imposed on the percentages of screen area available for each function.

The present invention enables the touch screen to be extended beyond the area of the display over which the touch screen is mounted. Touch-sensitive regions can thus be provided outside the display area. Because they are outside the display area, such regions do not reduce the display area available to the output function. A larger portion (potentially all) of the display area thus remains available for the output function. Moreover, because the invention does not tie the input function to touch symbols presented on the display area, a much larger region outside the display area can be made available for performing the input function. This greatly expands the scope of the input function, potentially eliminating the need for ancillary input devices such as keyboards. For example, the touch screen area outside the display area can be configured to simulate a keyboard adapted to perform a particular input function.

### SUMMARY OF THE INVENTION

In accordance with the preferred embodiment, the invention provides a touch screen with a display having a display area. A touch-sensitive panel is mounted in front of the display. The panel covers an area substantially larger than the display area.

The panel is notionally divided into a first portion which covers the display area and a second portion which covers an additional area peripheral to the display area. Touch symbols may be applied directly to the first and/or second portions of the panel. However, the touch symbols are preferably applied to a sheet which is mounted adjacent to the panel, covering both the first and second portions of the panel. The sheet has a first, transparent or cut out portion corresponding to the display area, and a second portion corresponding to the second portion of the panel. In most cases the touch symbols will be applied to the second portion of the sheet, although they may in some cases be applied to the first portion of the sheet. The symbols can be configured on the sheet to define a keyboard having a plurality of keys adapted to perform a generalized input function. The panel and the sheet can be sealed against water penetration.

### BRIEF DESCRIPTION OF THE DRAWINGS

FIG. 1 is a front elevation view of an extended touch screen constructed in accordance with the preferred embodiment of the invention.

FIG. 2 is a side elevation view of the extended touch screen of FIG. 1.

FIG. 3 is a rear elevation view of the extended touch screen of FIG. 1.

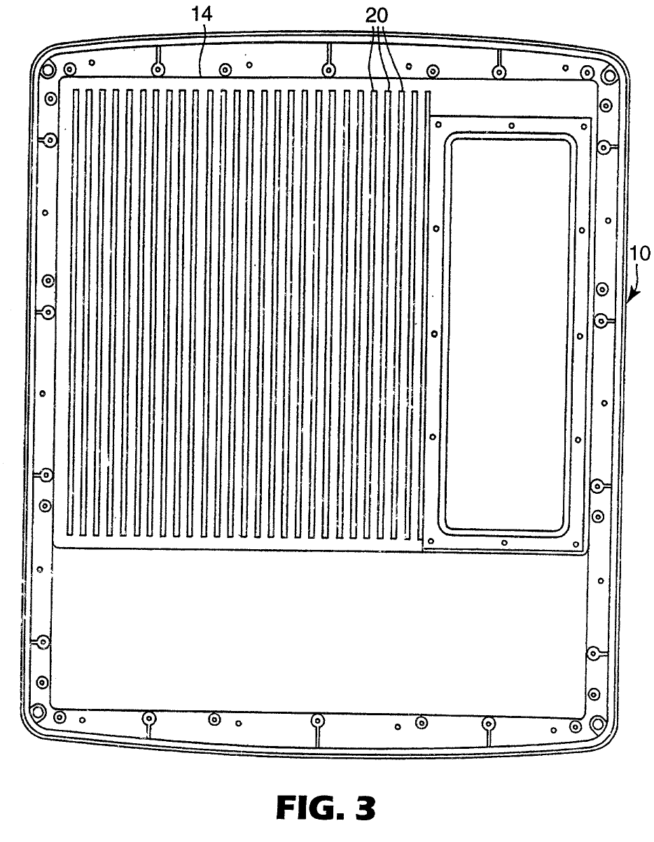

FIG. 4 repeats the front elevation view of FIG. 1, without the graphics-bearing overlay seen in FIG. 1.

FIG. 5 is a top plan view of the extended touch screen of FIG. 1.

### DETAILED DESCRIPTION OF THE PREFERRED EMBODIMENT

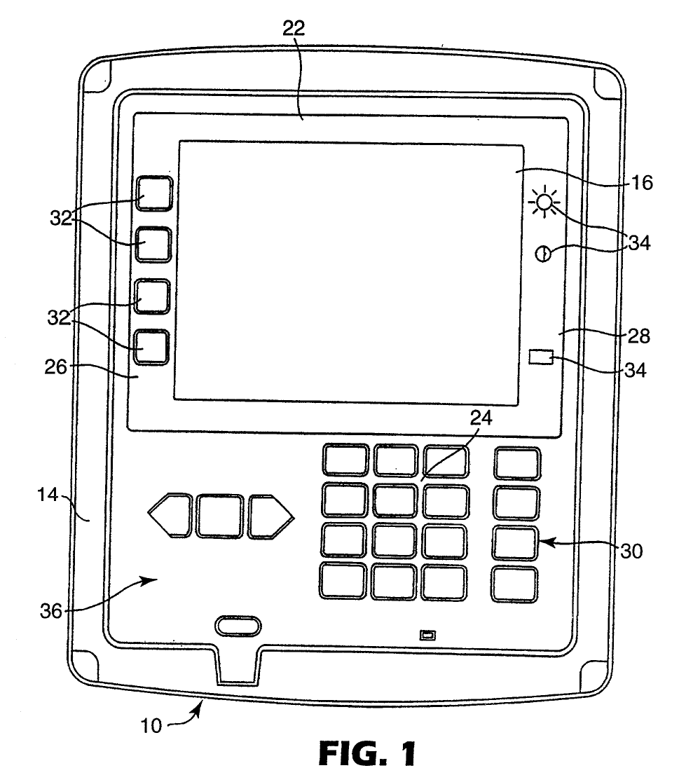

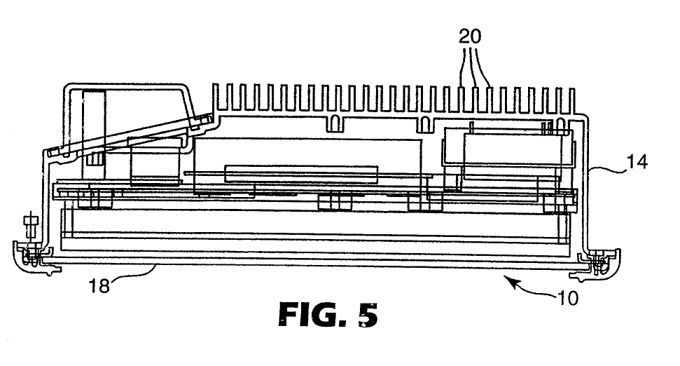

The drawings depict a touch screen assembly 10 having a display 12 which is housed within a sealed enclosure 14 together with the display's associated electronic control circuitry, and additional excitation/sensing circuitry associated with the touch-sensitive operation of assembly 10. Display 12 has a display area 16 (FIG. 1) on which information is displayed in conventional fashion. A transparent touch screen 18 (FIG. 5) is mounted in front of display 12, such that information appearing in display area 16 is visible through touch-sensitive panel (i.e. “touch screen”) 18. Enclosure 14 has rearwardly projecting fins 20 which dissipate heat generated during operation of the electronic components within enclosure 14. Enclosure 14 may be sized for convenient mounting within an equipment rack, or between a pair of building wall studs, etc.

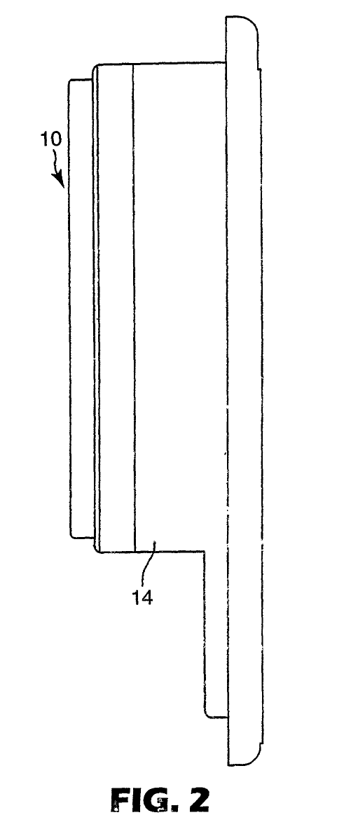

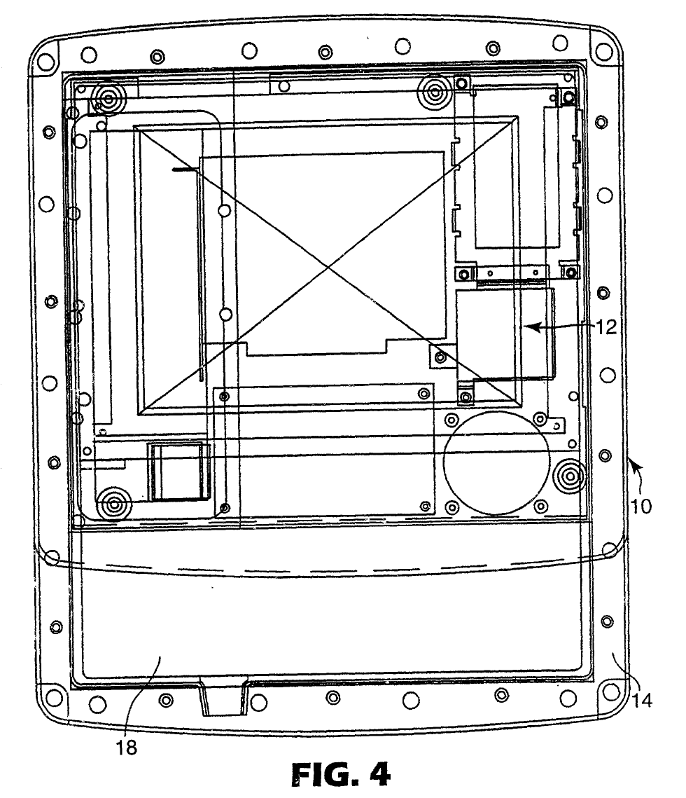

As best seen in FIGS. 1, 2 and 4, touch screen 18 extends beyond display area 16, covering not only display area 16, but also peripheral regions 22, 24, 26 and 28 which respectively extend above, below, and to either side of display area 16. Although display 12 can be operated to present touch symbols on display area 16 in conventional fashion, it is generally preferable to minimize the portion of display area 16 reserved for presentation of touch symbols. This maximizes the portion of display area 16 on which other information can be presented, without interfering with the input function associated with the operator's utilization of the touch symbols. This also allows certain touch symbols to be continuously visible, irrespective of anything appearing in display area 16. For example, touch symbols for controlling the contrast and backlighting of display 12 can be continuously visible. If these symbols were displayed in conventional fashion on display area 16 they might not be visible in some cases if the controls in question were improperly adjusted. It may similarly be desirable to ensure that touch symbols corresponding to “Help” and “Emergency” functions are continuously visible, irrespective of any thing appearing in display area 16.

The present invention allows touch symbols to be located in any of regions 22, 24, 26 or 28 without encroaching upon display area 16. For example, FIG. 1 depicts a first set of touch symbols 30 within region 24 below display area 16, a second set of touch symbols 32 within region 26 to the left of display area 16, and a third set of touch symbols 34 within region 28 to the right of display area 16. As may be seen, touch symbols 30, 32, 34 collectively cover an area roughly equivalent to display area 16. Accordingly, if touch symbols 30, 32, 34 were presented in conventional fashion on display 12, virtually all of display area 16 would have to be reserved for the touch symbols, with little or no display area remaining for presentation of information unrelated to the input function associated with the touch symbols.

It will thus be appreciated that the invention maximizes the portion of display area 16 available for presentation of information related or unrelated to the input function associated with the touch symbols, while simultaneously significantly increasing the portion of the touch screen available for presentation of information which is related to the input function associated with the touch symbols. Those skilled in the art will realize that regions 22, 24, 26 and 28 may accommodate a quantity of touch symbols sufficient to constitute a full function keyboard.

Because regions 22, 24, 26 and 28 lie outside display area 16, touch symbols 30, 32, 34 must be presented in non-conventional fashion (i.e. otherwise than by displaying them on display 12). The touch symbols could be silk-screened or otherwise applied directly on touch screen 18. But, if this approach were taken, it would be relatively laborious and expensive to remove the touch screen from service and replace it with another touch screen bearing different touch symbols. Accordingly, this approach effectively requires that the touch screen be dedicated to a particular task associated with touch symbols which are not expected to change throughout the useful lifetime of the touch screen.

A more flexible approach is to apply the touch symbols to a sheet 36 of the same size as the front face of touch screen 18. Sheet 36 has a transparent or cut out portion corresponding in size to display area 16. The remainder of sheet 36 is opaque or translucent, and bears the desired touch symbols. Sheet 36 can be mounted behind touch screen 18, with the transparent or cut out portion of sheet 36 overlying display area 16 such that information presented on display 12 is visible through touch screen 18 and sheet 36. Alternatively, sheet 36 can be bonded to the front of touch screen 18, with the transparent or cut out portion of sheet 36 overlying display area 16 as aforesaid. It will not likely be possible to mount sheet 36 in front of touch screen 18 without bonding the two together, since the gasket or bezel used to seal the outer edges would cause sheet 36 to bow outwardly away from screen 18 to an unacceptable degree.

The software which controls the touch screen's operation is used to define a plurality of application-dependent sub-regions within any or all of regions 22, 24, 26 and 28. Each sub-region corresponds to a site for an application-dependent touch symbol. The touch symbols are applied to sheet 36 such that when sheet 36 is mounted adjacent touch screen 18 as aforesaid, each touch symbol is precisely aligned with a corresponding software-defined sub-region on touch screen 18. Besides facilitating customization of overlay/underlay sheets bearing different touch symbols adapted to perform different input functions, this allows assembly 10 to be constructed without regard to any particular end use. A very large number of software-defined sub-regions are available as touch symbol sites. The number of sites actually occupied by touch symbols appearing on a particular sheet and the input function associated with each symbol is determined by the software. Parameters supplied during setup configuration or reconfiguration of assembly 10 define these characteristics.

The following procedure can be used to align display 12, touch screen 18 and sheet 36. The operator is prompted to touch opposing corners of display area 16. This action can be repeated as often as desired to ensure accurate location of the corners. The same action is then performed for selected points in any of regions 22, 24, 26 or 28. The two sets of coordinates so obtained (i.e. one set of coordinates for display area 16, and another set for regions 22, 24, 26 or 28) are dealt with separately. The mapping function associated with display area 16 (described below) takes precedence. An error margin is preferably defined around display area 16 to eliminate the possibility of overlap due to mechanical tolerances.

The coordinates associated with display area 16 are stored in a retrievable storage device. These coordinates define the bounds of a notional region which the software associates with display area 16. During normal operation, these coordinates are used to perform an initial test to see if a point touched by the operator lies inside or outside display area 16. If the touched point lies within the region associated with display area 16, scale and offset parameters (derived from the coordinates associated with display area 16) are used to locate the touched point relative to any touch symbols mapped by the software onto display area 16. If the touched point corresponds to any such symbol, control passes to appropriate software which performs the function associated with the touch symbol in question.

If the touched point lies outside the region associated with display area 16, different scale and offset parameters (derived from the calibration coordinates associated with regions 22, 24, 26 or 28) are used to locate the touched point relative to any touch symbols mapped by the software onto regions 22, 24, 26 or 28. If the touched point corresponds to any such symbol control again passes to appropriate control software which performs the function associated with the touch symbol in question.

It will thus be seen that the invention offers considerable flexibility as compared with conventional touch screen technology. Display area 16 can remain free of touch symbols for maximal flexibility in the display of output information. The enlarged touch symbol region available outside display area 16 can accommodate many more touch symbols than a conventional touch screen. Both the designer and the operator can therefore maintain an independent focus on the input and output functions respectively, in contrast to the interdependent focus required when display area 16 is used to display both touch symbols and output information unrelated to the input function associated with the touch symbols. Consequently, the designer may create a touch screen facility offering more input functions (including a full function keyboard) than a conventional touch screen, while maintaining a simplified operator interface which is both easy to understand and easy to use. Moreover, touch screen facilities constructed with the aid of the invention can easily be reconfigured to perform different tasks by substituting sheets bearing different symbols, and by making corresponding programming changes to the control software.

The invention also maximizes the usable surface of touch screen 18. It is not, for example, necessary that there be a bezel around display 12. Touch symbol-defined keys may extend right to the edge of display area 16. In some applications it may even be desirable to allow one or more touch symbols to extend across the edge of display area 16, which is also permitted by the invention. It is also possible to mount more than one display 12 behind a single touch screen 18.

In applications requiring waterproofing, the invention requires only a single seal to protect all components associated with both the input and output functions (i.e. with one seal display 12 and touch screen 18 can be sealed to form a single waterproof unit).

Sheet 36 to which the touch symbols are applied may be transparent. This provides maximum flexibility in customizing the background on which the touch symbols appear (i.e. the area visible through any or all or regions 22, 24, 26 or 28). The touch symbols can also be arbitrarily sized and located. In addition, with the aid of transparent label and electro luminescent film technology, touch symbol-bearing regions can be illuminated for low light or night time use.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A touch screen, comprising:
(a) a display having a display area; and,
(b) a touch-sensitive panel mounted in front of said display, said panel having an area substantially larger than said display area.

2. A touch screen as defined in claim 1, wherein said panel comprises a first portion covering said display area and a second portion covering an additional area peripheral to said display area.

3. A touch screen as defined in claim 2, further comprising touch symbols applied to said second portion.

4. A touch screen as defined in claim 2, further comprising a touch symbol-bearing sheet mounted adjacent said panel.

5. A touch screen as defined in claim 4, wherein said sheet has a first portion corresponding to said display area, and a second portion corresponding to said second portion of said panel.

6. A touch screen as defined in claim 5, wherein said second portion of said sheet bears said touch symbols.

7. A touch screen as defined in claim 4, wherein said sheet is removable and replaceable by a sheet bearing different touch symbols.

8. A touch screen as defined in claim 4, wherein said symbols are configured on said sheet to define a keyboard having a plurality of keys adapted to perform a generalized input function.

9. A touch screen as defined in claim 4, wherein said panel and said sheet are sealed against water penetration.
